(19) United States
(12) Patent Application Publication
(10) Pub. No.: US 2002/0124168 A1
(43) Pub. Date: Sep. 5, 2002

(54) Method and system for upgrading a user environment

(76) Inventors: Steven H. Mccown, Brighton, CO (US); Charles A. Milligan, Golden, CO (US); Jeffrey A. Knight, Erie, CO (US)

Correspondence Address: Timothy R. Schulte, Storage Technology Corporation, One StorageTek Drive, MS-4309, Louisville, CO, 80028-4309, US

(21) Appl. No.: 09/750,928

(22) Filed: Dec. 28, 2000

Related U.S. Application Data
(60) Provisional application No. 60/218,756, filed on Jul. 17, 2000.

(51) Int. Cl. G06F 12/14

(52) U.S. Cl. 713/166

(57) ABSTRACT

A method and system for enhancing a user environment having product with a component operable to run at a low operating level and a high operating level in which the component is set to operate at the low operating level includes associating an upgrade key with the product. The upgrade key has permission instructions for the component to operate at the high operating level. The component is then enabled to operate at the high operating level in response to the upgrade key being associated with the product in order to upgrade the user environment.

CROSS-REFERENCE TO RELATED APPLICATIONS

This application claims the benefit of U.S. provisional application Ser. No. 60/218,756 filed Jul. 17, 2000.

### TECHNICAL FIELD

The present invention relates generally to methods and systems for upgrading a user environment by managing access to and payment for products, facilities, services, and functions that have been conveniently stored or established at customer locations and, more particularly, to a method and system for making available for use (permanently or conditionally) a product, facility, service, or function such as are found in a computer system, or upgrading the apparent usable version of such which is resident but not available via an upgrading mechanism enabling unavailable features to be made available.

### BACKGROUND ART

In many industries, a user environment is defined by a product line or a set of services (e.g., appliances, tools, computers, transportation, etc.) which includes a similar base offering having numerous differing options which often include significant enhancements or companion offerings supplied by other vendors. This practice will probably continue with emerging technologies such as virtual reality, wearable computing, and interactive entertainment systems. In most instances, the ability for a potential customer to upgrade their environments and make use of such offerings whole or in part is gated by the ability to contact the vendor or vendors directly. However, such contact is not generally possible at the times of most immediate need to make use of the enhancing products and services.

One example in the computer industry is with storage products which allow one to configure a variable amount of buffering in the controller in front of the drive. Another example is with arrays of devices such as RAID and RAIT where the width of the striping, the type and amount of redundancy, and the availability of spare resources can be varied. A further example is personal computers, especially laptops, that are all made with a set of consistent base options (e.g., CPU, hard disk, RAM, keyboard, display screen, operating system, application software set, e-commerce applications, etc.). However, different models of these computers have significant differences such as how much RAM is available, the size of the hard disk, the software application set supplied or installed later by the customer such as development tool kits, function servers (e.g., storage servers), and workstation software (e.g., office suites, word processors, etc.).

In the manufacturing and configuration process, each computer model is setup differently (e.g., 500 MHZ vs. 700 MHZ central processing units (CPUs), 5+1 RAID5 vs. RAID3 storage, 1GB vs. 4 GB controller buffering, server vs. workstation software, etc.) and many are manufactured specifically to individual customer specifications. Having multiple options available as different modes requires additional development and manufacturing overhead to assemble and test similar albeit different products. For the general consumer who purchased a base set of product features, enhancing the system (i.e., adding companion products or services or upgrading the existing set that are used) can be a daunting, if not impossible, task requiring specialized technical skills. Many consumers do not add companion offerings to or upgrade their products environments because it is either too difficult or requires expert skills or is extremely costly. Many manufacturers do not support upgrading for the same reasons. As a result, upgrading an environment via such things as providing access to companion products or supporting upgrades to installed products can be a good source of revenue for a business if the upgrading process is made simple for the consumers and if the costs can be contained. Making the upgrading process easy with a low cost will open a large consumer market that is largely ignored.

It is desirable to create a method and system by which a consumer could immediately and inexpensively upgrade an environment. Such a method and system encompass having the consumer purchase and initiate use of one or more services, products, or features of same without the need for specialized skills or assistance from a manufacturer or vendor. For example, it is desirable for a non-technical user to be able to upgrade a computing environment from a 500 MHZ to a 700 MHZ CPU, from 64 MB to 128 MB of RAM, or install additional software along with existing software without having to open the computer or wait for shipments. If such upgrades or installations could take place immediately upon the consumer recognizing a need, then the value to vendors and users is greatly increased.

### SUMMARY OF THE INVENTION

The present invention applies in all its following objects to both products (e.g., computer hardware and software) and services (e.g., the ONSTAR system), and applies to both the upgrading of a product that is apparently installed for use (e.g., make the CPU in a computer run at a higher speed) and the installation of a product that is noticeably not installed (e.g., install a word processing program not now used), and applies to both hardware installation or upgrade (e.g., a system to lay out logic diagrams such as Mentor), and applies to content installation or upgrade (e.g., figures or images in a library), and also applies to permanent or unconditional changes (e.g., purchase) as well as temporary and conditional changes (e.g., lease for one time use).

Accordingly, it is an object of the present invention to provide a method and system for upgrading a user environment having a turned off set of features which are individually or in groups turned on upon an upgrading mechanism enabling the turned off features to be turned on in order to upgrade the functionality and service of the user environment.

It is another object of the present invention to provide a method and system for upgrading a user environment having a disabled set of features in which the disabled enhanced features are individually or in groups enabled upon an enabling mechanism triggering the enablement of the disabled enhanced feature in order to upgrade the user environment.

It is a further object of the present invention to provide a method and system for upgrading a user environment having a relatively low operating performance level and disabled higher performance levels in which one of the higher performance levels is enabled and becomes the operating performance level upon an enabling mechanism triggering the enablement of the higher performance level in order to upgrade the user environment.

It is still another object of the present invention to provide a method and system for upgrading a virtual entry level product having locked functionality in which the locked functionality is unlocked in order to upgrade the product.

It is still a further object of the present invention to provide a method and system for upgrading a user environment having an operating option and an inventory of stored options in which one of the stored options becomes the operating option in response to instructions from an unlocking option mechanism in order to upgrade the user environment.

It is still yet another object of the present invention to provide a method and system for upgrading a user environment having enabled and disabled features in which one of the disabled features becomes enabled upon associating an upgrade key (which can be a hardware entity, a software routing, or authorizing permission such as a password or encryption key) with the user environment in order to upgrade the user environment.

It is still yet a further object of the present invention to provide a method and system for upgrading a user environment having an electronic component with an enabled low operating performance level and a disabled high operating performance level in which the disabled high operating performance level of the electronic component is enabled by an upgrading mechanism having permission to enable the high operating performance level.

It is still yet another object of the present invention to provide a method and system for upgrading a given product of a product line in which each product in the product line is capable of a high level of functionality but the given product is configured to operate at a low level of functionality and then upgraded to operate at the high level of functionality upon receiving permission to upgrade from an upgrading mechanism.

It is still yet a further object of the present invention to provide a method and system for upgrading a user environment having an electrical component in which the electrical component is capable of a high level of functionality but is configured to operate at a low level of functionality and then upgraded to operate at the high level of functionality within the user environment receiving permission to upgrade from an upgrading mechanism.

In carrying out the above objects and other objects, the present invention provides a method for upgrading a user environment. The user environment has a product with a component operable to run at a low operating level and a high operating level. The component of the product is set to operate at the low operating level. The method includes associating an upgrade key with the product. The upgrade key has permission instructions for the component of the product to operate at the high operating level. The component of the product is then enabled to operate at the high operating level in response to the upgrade key being associated with the product in order to upgrade the product.

The method may further include associating a security mechanism with products in the environment. The security mechanism contains permission instructions for the component of a product to run at the low operating level. The security mechanism updates the permission instructions for the component to run at the high operating level upon the upgrade key being associated with the product.

In carrying out the above objects and other objects, the present invention further provides a system for upgrading an environment such as a computer system. The computer system has a component such as a central processing unit, RAM, a hard disk, and the like operable to run at a low operating level and a high operating level. The component of the computer is set to operate at the low operating level. The system includes an upgrade key having permission instructions for the component of the computer to operate at the high operating level. The system further includes an enabling mechanism for enabling the component of the computer to operate at the high operating level in response to the upgrade key being associated with the computer in order to upgrade the computer.

The above objects and other objects, features, and advantages of the present invention are readily apparent from the following detailed description of the best mode for carrying out the present invention when taken in connection with the accompanying drawings.

### BRIEF DESCRIPTION OF THE DRAWINGS

FIG. 1 illustrates a manufacturing process of a product of a product line in accordance with the method and system of the present invention; and

FIG. 2 illustrates an upgrading process of the product of the product line shown in FIG. I in accordance with the method and system of the present invention.

### BEST MODES FOR CARRYING OUT THE INVENTION

In general, the present invention is a method and system for upgrading a user environment which contains or makes use of a product or service of an offering in which each product or service has an identical component, such as an electrical component or software or report, having different operating levels or where each product or service can be substituted for some other product or service. The products or services of the offering are intended to be sold to consumers. For instance, the service could be a global positioning service with mapping and direction support that is paid on a regional basis. The initial installation appears to the user to support only the home local of the user. The upgrade would appear to broaden the area covered to include neighboring locations. Additional upgrades could broaden the service to national or continental proportions.

Another example is a product such as a computer where one of the electrical components is a central processing unit (CPU) capable of running at different operating speeds, i.e., 300 MHZ, 500 MHZ, and 700 MHZ. The manufacturer sets the electrical component of a first set of products in the product line to run at a low operating speed (300 MHZ) even though the electrical component may run at a higher operating speed (500 MHZ or 700 MHZ). The manufacturer sets the electrical component of a second set of products in the product line to run at a high operating speed (500 MHZ) even though the electrical component may run at yet a higher operating speed (700 MHZ).

In essence, the electrical component of each computer in the product line is an identical 700 MHZ CPU that may be set at lower operating speeds. The manufacturer prices each computer in the first set of products at a low price to reflect the low operating speed of the electrical component and prices each computer in the second set of products at a high price to reflect the high operating speed of the electrical component.

A consumer selects a computer for purchase depending upon the needs of the consumer with respect to the operating speed of the electrical component and the budget of the consumer. For instance, if the consumer has a low budget and does not need a higher cost computer having the electrical component running at the high operating speed then the consumer purchases the lower cost computer having the electrical component running at the low operating speed. In the past, if the consumer desired at some point in the future after purchasing the computer that a faster electrical component operating speed is desired then the consumer would have to upgrade the computer by replacing the slow electrical component with a faster electrical component, i.e., replacing a 300 MHZ CPU with a 500 MHZ CPU or a 700 MHZ CPU.

The present invention provides a method and system for enabling the consumer to upgrade the lower cost computer such that the electrical component will run at a higher operating speed. The present invention avoids the prior art practice of requiring the slower electrical component being replaced with a faster electrical component by enabling an inherently fast electrical component running at a low operating speed to be upgraded to run at a higher operating speed.

In operation, the manufacturer gives each consumer purchasing a computer an interactive security mechanism. One such security mechanism could be a smart card. The consumer uses the interactive security mechanism to unlock secured features of the purchased computer. The smart card corresponds to the individual computer identification and the electronic component operating level of the purchased computer. After deciding to upgrade the computer, the consumer purchases an upgrade key specific to the individual computer and then loads the upgrade key onto the smart card. The upgrade key includes permission data for enabling the electrical component to be run at the high operating speed instead of the low operating speed. For instance, the upgrade key may include a first key for upgrading the computer to run at the medium speed or a second key for upgrading the computer to run at the highest speed. The cost of the upgrade keys may be a function of the amount of upgrading.

The facility for acquiring rights to use the upgrade key including methods of remuneration to the key owners may in fact be embedded in the security mechanism itself. This allows the legal requirements such as licensing, the physical enabling for use, the actual use, and the payment steps which are all aspects of a commercial transaction to occur out of order or in a variety of ways. For example, the request to use a specific software routine that is shipped with a computer system could be enabled at the time the user identifies a particular need by interaction with the logic embedded in the user's smart card. The licensing information could be first enabled and the user decides to license for a single use and agrees to the payment which is acknowledged and stored in the smart card. Then the product is enabled and the user uses the product. After the single use, the product is again disabled by the system. If the user decides later to reenable the product for a second single use that transaction is also recorded in the smart card and the enable/use/disable process repeated. If the user then later decides to purchase the product, the previous single uses are forgiven and the purchase is recorded in the smart card. Later when the user accesses an online service such as e-mail or an Internet connection, the system first makes contact with the vendor of the product and logs the purchase and makes the payment the user has previously authorized.

The consumer inserts the smart card into the computer in order to begin an upgrade session. Upon recognizing the smart card, the computer installs the available keys loaded on the smart card. For any installed key, the computer unlocks the enhanced feature, i.e., higher operating speed of the electrical component, and then makes the enhanced feature available to the consumer thereby upgrading the computer.

The upgrade keys of the smart card can be made specific to a particular instance of the product, i.e., the particular computer purchased by the consumer. As a result, it is possible to preclude the upgrade keys from being transferred to another consumer. The upgrade keys may be produced via a cryptographic function such that they cannot be simply derived even by technically savvy consumers.

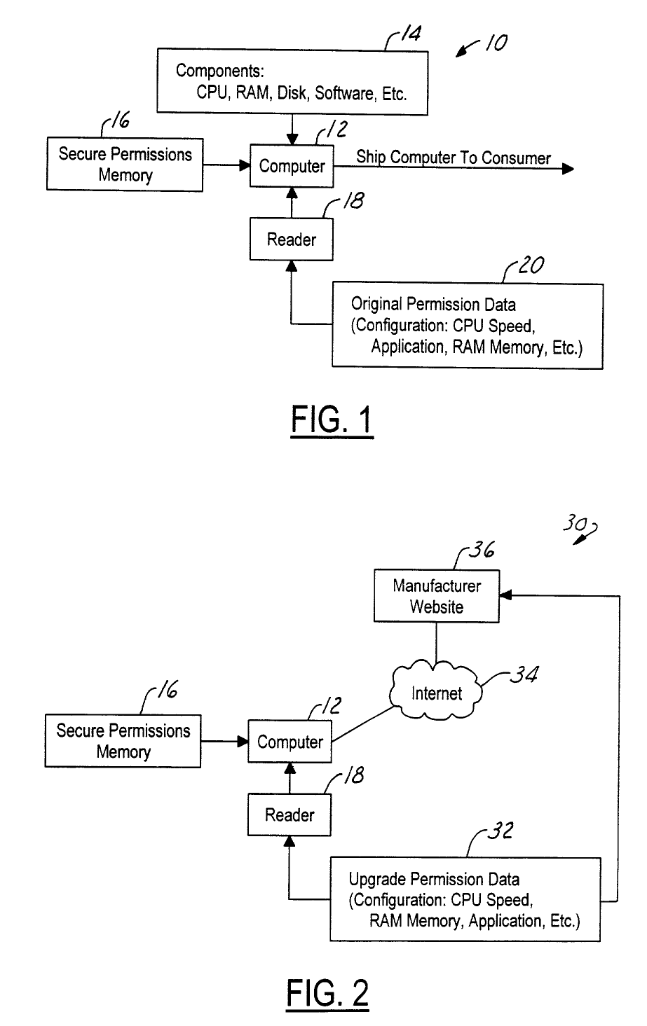

Referring now to FIG. 1, a manufacturing process 10 of a product in a product line in accordance with the method and system of the present invention is shown. As an example, the manufacturing process of a computer 12 is shown in FIG. 1. Each computer 12 in the product line includes a plurality of features such as a central processing unit (CPU), a hard disk, random access memory (RAM), software, etc. as shown in block 14. For example, each computer 12 in the product line is created with a 700 MHZ CPU, 256 MB of RAM, 25 GB hard disk, common operating systems, and common application software. Creating computers having identical components and features simplifies manufacturing, broadens the target market, and reduces overhead.

Each feature of computer 12 is capable of different levels of performance. For instance, the CPU may run at 300 MHZ, 500 MHZ, or 700 MHZ; the RAM may handle 64 MB, 128 MB, or 256 MB of memory; the hard disk may handle 6 GB, 12 GB, or 25 GB of memory; the common operating system may be workstation or server operating system software; and the application software may be accounting software, word processing software, and the like.

In order for the manufacturer to sell computers having different levels of functionality (e.g., CPUs with 300 MHZ, 500 MHZ, or 700 MHZ processors, or servers vs. workstation software), some aspects of the functionality can be locked and made unavailable to the consumer. This allows the consumer to purchase a virtual entry level computer for a reduced cost. The inventory of all options available (i.e., that which can be installed and that which can be upgraded though most generally not enabled) may be viewed by the consumer of the computer by direct request or may be prompted to the consumer via helping routines such as wizards or tool tips. It can be easily inspected and used to enable available features and options thereby enabling immediate use when need arises. The inventory of the options can reflect factory installed functions and software, but can be updated to reflect subsequently installed functions and software (e.g., via a compact disc or download).

Computer 12 includes a secure permissions memory hardware device 16 such as EEPROM. Memory device 16 includes operating instructions for each component and feature of computer 12. Each operating instruction instructs the associated component and feature to operate at a certain level of performance. For example, the operating instruction for the CPU may be to instruct the CPU to run at 300 MHZ during operation even though the CPU can run at a higher speed such as 700 MHZ. Similarly, the operating instruction for the RAM may be to instruct the RAM to hold 64 MB of memory during operation even though the RAM may hold 256 MB of memory.

Computer 12 includes a reading device 18 for receiving operating instructions from an external source and to provide the received instructions to memory device 16. As an example, reading device 18 is a smart card reader. During manufacturing, the manufacturer transmits the original operating instructions from an external device, such as a smart card 20, to smart card reader 18 by inserting the smart card into the smart card reader. Smart card 20 includes the operating instructions or permissions data indicative of how each component and feature of computer 12 is to be configured. The permissions data includes configuration instructions for CPU speed, operating software, application software, and the like. Upon receiving smart card 20, smart card reader 18 transmits the configuration instructions to memory device 16. Memory device 16 then provides the configuration instructions to each component and feature of computer 12. In response, each component and feature of computer 12 is configured to operate in accordance with its respective configuration instruction.

Referring now to FIG. 2, an upgrading process 30 of computer 12 in accordance with the method and system of the present invention is shown. In general, when a consumer chooses to upgrade or modify computer 12 (e.g., a computer laptop from a 300 MHZ CPU to a 700 MHZ CPU, or a workstation to a server, etc.) the consumer simply purchases a smart card 32 having a cryptographic upgrade key and then inserts the smart card into smart card reader 18. The cryptographic upgrade key includes a new set of operating instructions for at least one feature or component of computer 12. For instance, the new set of operating instructions may include instructions to upgrade the CPU to run at a faster speed. Upon reading smart card 32, smart card reader 18 transfers the new set of operating instructions to memory device 16. Memory device 16 then instructs each feature of computer 12 to operate in accordance with the new set of instructions contained on smart card 32. For example, the CPU of computer 12 is upgraded to run at a faster speed such as 500 MHZ instead of the previous operating speed of 300 MHZ.

In effect, memory device 16 updates the inventory of options of computer 12 to function in accordance with the new set of operating instructions. In order to upgrade computer 12, the new set of instructions include permissions data for instructing the components of computer 12 to run at a higher functioning or operating level. Because computer 12 was originally created with the enhanced features disabled, such as a CPU capable of running at a fast CPU speed but originally configured to run at a low operating speed, and with numerous applications resident, those features or applications can be enabled in accordance with the method and system of the present invention without having to perform highly technical maintenance that is beyond the ability of most consumers.

In addition to loading a smart card 32 having the cryptographic upgrade key with the new set of operating instructions into smart card reader 18 the consumer may directly receive the cryptographic upgrade key over a computer network such as the Internet 34 from an Internet site 36 of the manufacturer. In this case, the cryptographic upgrade key is directly loaded via the Internet 34 into memory device 16 of computer 12. Memory device 16 then enables the components and features of computer 12 to function in accordance with the new set of instructions.

The following table illustrates the upgrading process of computer 12 in accordance with the method and system of the present invention.

| | BEFORE UPGRADE | AFTER UPGRADE |
|---|---|---|
| CPU speed: | 300 MHZ | 500 MHZ |
| 00-070-DSK | | |
| Avail. RAM: | 64 MB | 128 MB |
| Avail. Disk space: | 2 GB | 4 GB |
| Operating System: | Workstation | Workstation, Server |
| Applications: | Word processing | Word processing, |
| | | Accounting |

As explained above, the values for each component and feature may be contained in a central table and/or in each individual component. At boot time, these values are loaded from the secure EEPROM that contains them.

The method and system of the present invention enable smart card management of the process of unstrapping functions or resources, i.e., allowing the function to execute or be used in some manner. Different levels of functions may be unstrapped (e.g., allowing some consumers more access to functions or resources than other consumers, or allowing only a part of the available function or resource to be made available according to a set of rules such as lease payment vs. purchase payment). Different levels of unstrapped functions may be re-strapped (e.g., when a lease period expires). The process of unstrapping and re-strapping can be executed repeatedly. The rights of the consumer in upgrading components of the environment may be authenticated (i.e., verifying the rights to use the specific smart card before allowing any unstrapping). This includes re-strapping when an unauthorized use of the smart card is detected. Automatic payment processes may be invoked when unstrapping is requested including single time use, repetitive use, lease to own, and purchase. The present invention also supports batched, aggregated, and delayed delivery of funds by storage on the smart card until a delivery vehicle is available (e.g., when the smart card is used in conjunction with an email or an Internet access application, the financial transaction can be automatically executed before the application is enabled).

Thus it is apparent that there has been provided, in accordance with the present invention, a method and system for upgrading a user environment that fully satisfy the objects, aims, and advantages set forth above. While the present invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

What is claimed is:

1. A method for upgrading a user environment, wherein the user environment has a product with a component operable to run at a low operating level and a high operating level, the component of the product being set to operate at the low operating level, the method comprising:
associating an upgrade key with the product, the upgrade key having permission instructions for the component of the product to operate at the high operating level; and
enabling the component of the product to operate at the high operating level in response to the upgrade key being associated with the product in order to upgrade the user environment.

2. The method of claim 1 further comprising:
associating a security mechanism with the product, the security mechanism containing permission instructions for the component of the product to run at the low operating level, wherein the security mechanism updates the permission instructions for the component to run at the high operating level upon the upgrade key being associated with the product.

3. The method of claim 1 wherein:
the product is a computer.

4. The method of claim 3 wherein:
the component is a central processing unit of the computer.

5. The method of claim 3 wherein:
the component is a hard disk of the computer.

6. The method of claim 3 wherein:
the component is random access memory of the computer.

7. The method of claim 3 wherein:
the component is software of the computer.

8. The method of claim 1 wherein:
the upgrade key is a cryptographic update key.

9. The method of claim 1 wherein:
associating an upgrade key with the product includes associating a smart card having the upgrade key with the product.

10. The method of claim 1 wherein:
associating an upgrade key with the product includes transferring the update key from the Internet to the product.

11. The method of claim 1 further comprising:
disabling the component of the product from operating at the high operating level in response to the upgrade key being associated with the product after expiration of a lease period.

12. The method of claim 1 wherein:
enabling includes enabling the component of the product to operate at the high operating level for a single use of the product.

13. The method of claim 1 wherein:
enabling includes enabling the component of the product to operate at the high operating level for multiple uses of the product.

14. The method of claim 1 wherein:
enabling includes enabling the component of the product to operate at the high operating level permanently.

15. The method of claim 1 wherein:
enabling includes enabling the component of the product to operate at the high operating level temporarily.

16. A system for enhancing a user environment, wherein the user environment has product with a component operable to run at a low operating level and a high operating level, the component of the product being set to operate at the low operating level, the system comprising:
an upgrade key having permission instructions for the component of the product to operate at the high operating level; and
an enabling mechanism for enabling the component of the product to operate at the high operating level in response to the upgrade key being associated with the product in order to upgrade the user environment.

17. The system of claim 16 wherein:
the enabling mechanism includes a security mechanism containing permission instructions for the component of the product to run at the low operating level, wherein the security mechanism updates the permission instructions for the component to run at the high operating level upon the upgrade key being associated with the product.

18. The system of claim 16 wherein:
the product is a computer.

19. The system of claim 18 wherein:
the component is a central processing unit of the computer.

20. The system of claim 18 wherein:
the component is a hard disk of the computer.

21. The system of claim 18 wherein:
the component is random access memory of the computer.

22. The system of claim 18 wherein:
the component is software of the computer.

23. The system of claim 16 wherein:
the upgrade key is a cryptographic update key.

24. The system of claim 16 wherein:
the upgrade key is contained on a smart card.

25. The system of claim 16 wherein:
the upgrade key is contained in data of the Internet.

26. A method for upgrading a user environment, wherein the user environment has a service operable to run at a low operating level and a high operating level, the service being set to operate at the low operating level, the method comprising:
associating an upgrade key with the service, the upgrade key having permission instructions for the service to operate at the high operating level; and
enabling the service to operate at the high operating level in response to the upgrade key being associated with the service in order to upgrade the service.
